(19) United States
(12) Patent Application Publication
(10) Pub. No.: US 2025/0386414 A1
(43) Pub. Date: Dec. 18, 2025

(54) LIGHT ASSEMBLY CONTROLLER

(71) Applicant: Videndum Production Solutions Inc., Shelton, CT (US)

(72) Inventors: David Pasko, Middlebury, CT (US); Michael Herbert, London (GB); Bo Christensen, Nordborg (DK); Wei Cao, Shanghai (CN); Min Shi, Shanghai (CN); Dan Chen, Shanghai (CN)

(21) Appl. No.: 19/234,885

(22) Filed: Jun. 11, 2025

Related U.S. Application Data
(60) Provisional application No. 63/659,136, filed on Jun. 12, 2024.

(51) Int. Cl. H05B 47/18; F21V 29/61; F21Y 115/10; H05B 47/19

(52) U.S. Cl. CPC H05B 47/184; F21V 29/61; H05B 47/19; F21Y 2115/10

(57) ABSTRACT

A controller configured to modify an operation of a LED assembly is provided. The controller includes at least one processor, at least one LED driver, and a fan driver. The LED driver(s) are configured to electrically couple to at least one LED of the LED assembly, where at least one reflector disposed at a front portion of the LED assembly surrounds the LED(s). The fan driver is configured to electrically couple with a fan of the LED assembly, where a shroud surrounds the fan and extends from a rear portion of the LED assembly towards the front portion, and where at least one vent of the LED assembly is in fluid communication with the shroud. The processor(s) are configured to receive external commands to modify, utilizing the LED driver(s), an optical output of the LED(s), and modify, utilizing the fan driver, a speed of the fan.

### CROSS-REFERENCE TO RELATED APPLICATIONS

This application claims priority to U.S. Provisional Patent Application No. 63/659,136, filed Jun. 12, 2024 and titled “LIGHT ASSEMBLY CONTROLLER”, the contents of which are hereby incorporated by reference in its entirety.

### BACKGROUND

The field of the disclosure relates to lighting, and more particularly, to control systems for light panels formed from a plurality of discrete light emitting diode assemblies for still picture, video, and film production environments.

Lighting systems are used in many scenarios to provide high-quality lighting for use in still picture, video, and film production environments. An array of light emitting diodes (LEDs) of a LED may provide the desired lighting. LEDs are energy efficient and last longer than other types of lighting systems, such as incandescent lights or fluorescent lights. Legacy lighting systems typically include large housings and reflectors that focus the optical output of high intensity incandescent lights or florescent lights. However, legacy lighting is typically bulky, draws a large amount of electrical power, and consequentially, generates a large amount of heat.

Thus, it would be desirable to provide additional lighting capability for still picture, video, and film production environments using LED lighting systems.

### BRIEF DESCRIPTION

In one embodiment, a system including a controller configured to modify an operation of a LED assembly is provided. The controller includes at least one processor, at least one LED driver, and a fan driver. The at least one LED driver is configured to electrically couple to at least one LED of the LED assembly, where at least one reflector disposed at a front portion of the LED assembly surrounds the at least one LED. The fan driver is configured to electrically couple with a fan of the LED assembly, where a shroud surrounds the fan and extends from a rear portion of the LED assembly towards the front portion, and where at least one vent of the LED assembly is in fluid communication with the shroud. The at least one processor is configured to receive external commands to modify, utilizing the at least one LED driver, and optical output of the at least one LED of the LED assembly based on the external commands, and modify, utilizing the fan driver, a speed of the fan based on the external commands.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1 depicts a front view of a LED assembly in an exemplary embodiment.

FIG. 2 depicts a side view of the LED assembly of FIG. 1 in an exemplary embodiment.

FIG. 3 depicts a rear view of the LED assembly of FIG. 1 in an exemplary embodiment.

FIG. 4 depicts a isometric front view of the LED assembly of FIG. 1 in an exemplary embodiment.

FIG. 5 depicts an isometric front view of the LED assembly of FIG. 1 along cut lines A-A in an exemplary embodiment.

FIG. 6 depicts an isometric front view of the LED assembly of FIG. 1 with a diffuser panel in an exemplary embodiment.

FIG. 7 depicts an isometric rear view of the LED assembly of FIG. 1 with a rear panel removed in an exemplary embodiment.

FIG. 8 depicts a front view of a LED panel that utilizes an array of the LED assemblies of FIG. 1 in an exemplary embodiment.

FIG. 9 depicts a rear view of the LED panel of FIG. 8 in an exemplary embodiment.

FIG. 10 depicts an isometric front view of the LED panel of FIG. 8 in an exemplary embodiment.

FIG. 11 depicts an isometric rear view of the LED panel of FIG. 8 in an exemplary embodiment.

FIG. 12 depicts a rear view of another LED panel that includes an array of LED assemblies in an exemplary embodiment.

FIG. 13 depicts an isometric rear view of the LED panel of FIG. 12 in an exemplary embodiment.

FIG. 14 depicts an isometric front view of the LED panel of FIG. 12 in an exemplary embodiment.

FIG. 15 depicts an isometric side view of the LED panel of FIG. 12 in an exemplary embodiment.

FIGS. 16 and 17 depict isometric side views of the LED panel of FIG. 12 in exemplary embodiments.

FIG. 18 depicts a block diagram of a controller for a LED assembly in an exemplary embodiment.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general-purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a non-transitory computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

As discussed briefly above, legacy lighting that utilizes incandescent bulbs or florescent bulbs are large, heavy, and utilize a significant amount of electrical power. Further, legacy lighting lacks the flexibility for scaling the lighting to support different lighting requirements, varying the color temperature of the lighting, providing non-mechanical beamforming, etc.

In the embodiments described herein, control systems are provided that control the operation of LED assemblies. The LED assemblies may be arranged in an array to provide a LED panel. The LED assemblies include one or more reflectors that surround LEDs. The LED assemblies may include connections for routing electrical power and communications between the LED assemblies when the LED assemblies are arranged as an array within the LED panel. During operation, controller(s) of the LED assemblies may communicate with external devices in order to control the operation of the LED panel. For example, the controllers may communicate with a user's smart phone or tablet to control the operation of the LED panel. In some embodiments, a controller in a LED panel may operate as a primary controller, communicating with and receiving command from, external devices, and the primary controller may communicate with secondary controllers in the LED panel using wired or wireless interfaces to control the operation of the LED panel.

In some embodiments, the controllers in the LED assemblies in the LED panel are individually addressable, which allows the controllers to be individually controlled to each output, at their respective LED assemblies, a pre-defined output.

In some embodiments, the LED assemblies include a display, and/or a user interface, which allows the controllers of the LED assemblies to be individually controlled by a user. In different embodiments, the external control systems may utilize wired and/or wireless interfaces to communicate with the LED assemblies of the LED panel. In one embodiment, the controllers of the LED assemblies may include one or more wired communication channels that interface different LED assemblies together when the LED assemblies are organized into an array of LED assemblies, allowing the controllers of the LED assemblies to communicate with each other and/or with external devices. In another embodiment, the controllers of the LED assemblies include wireless interfaces (e.g., Wi-Fi, Bluetooth, near field communication. etc.), which provides a communication path between the controllers and the external devices.

In some embodiments, a user may utilize a smartphone to control the controllers of the LED assemblies and/or the LED panel. For example, the user may download an application to their smart phone, and utilize one or more wireless interfaces of the smartphone to control the controllers of the LED assemblies and/or the LED panel. Using the application on a smart phone, the user may modify various operating criteria of the controllers of the LED assembly. The user may use the application to download images, symbols, letters, and the like to the controllers of the LED assemblies in order to display various features on the LED panel, such as images, text, and patterns.

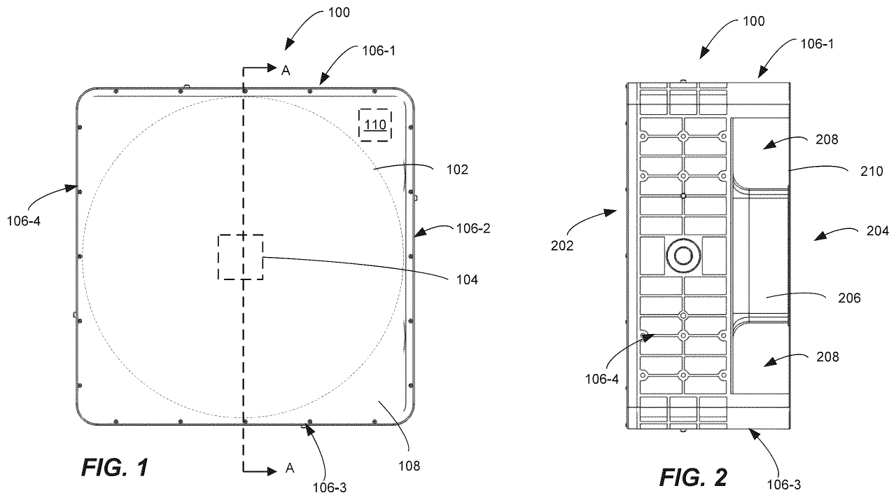

FIG. 1 depicts a front view of a LED assembly 100 in an exemplary embodiment. In this embodiment, LED assembly 100 includes at least one reflector 102. Although LED assembly 100 is depicted as having one reflector 102 in this embodiment, LED assembly 100 may have a different number in other embodiments. Reflector 102 includes one or more LEDs 104, which generate an optical output. LEDs 104 may be organized in any manner in order to generate an optical output. For example, LEDs 104 may implement various color temperatures using different LED devices, which allows LED assembly 100 to generate an optical output at different colors. LEDs 104 may be controllable as a group, individually, or as different arrays of LEDs 104 within reflector 102, which may allow LED assembly 100 to generate a specific pattern such as letters, numbers, symbols, pictures, etc.

In this embodiment, LED assembly 100 is shaped as a square having a plurality of sides 106-1, 106-2, 106-3, 106-4. Sides 106-1, 106-2, 106-3, 106-4 may include interlocking features (not shown) which enable a plurality of LED assemblies 100 to be connected together to form a LED panel. The interlocking features may include channels, protrusions, and the like, which when LED assemblies 100 are fitted together, form an array of LED assemblies 100.

In this embodiment, LED assembly 100 includes a diffuser panel 108 that partially obscures reflector 102 and LEDs 104. Diffuser panel 108 operates to diffuse the light generated by LEDs 104. Diffuser panel 108 is in front of both reflector 102 and LEDs 104, and therefore, Diffuser panel 108 is located in an optical output path of LEDs 104.

Sides 106-1, 106-2, 106-3, 106-4 of LED assembly 100 may further include power and/or communication connections that enable a controller 110 of LED assembly 100 to be controlled and powered when LED assembly 100 is assembled into a LED panel. The power and/or communication connections may include interlocking pins, connectors, metal pads, protrusions, etc., which, when LED assembly 100 is part of an array of LED assemblies 100 forming a LED panel, enable power and/or communication to any controller 110 of LED assembly 100 within the LED panel. In some embodiments, the communication connections comprise digital multiplex (DMX) connections which allow controllers 110 of LED assembly 100 to communicate with each other when LED assembly 100 is assembled into a LED panel.

FIG. 2 depicts a side view of LED assembly 100 of FIG. 1 in an exemplary embodiment. FIG. 2 illustrates that LED assembly 100 includes a front portion 202 and a rear portion 204 opposing front portion 202. Front portion 202 includes reflector 102 (see FIG. 1). In this embodiment, LED assembly 100 includes a shroud 206 that extends from rear portion 204 towards front portion 202. Shroud 206 surrounds a fan (not shown), which draws air into shroud 206, directs the air over the internal components of LED assembly 100, and discharges the air from vents 208. Vents 208 are in fluid communication with shroud 206 and may circumscribe shroud 206 to improve the airflow through LED assembly 100 such that each of sides 106-1, 106-2, 106-3, 106-4 of LED assembly 100 includes one of vents 208.

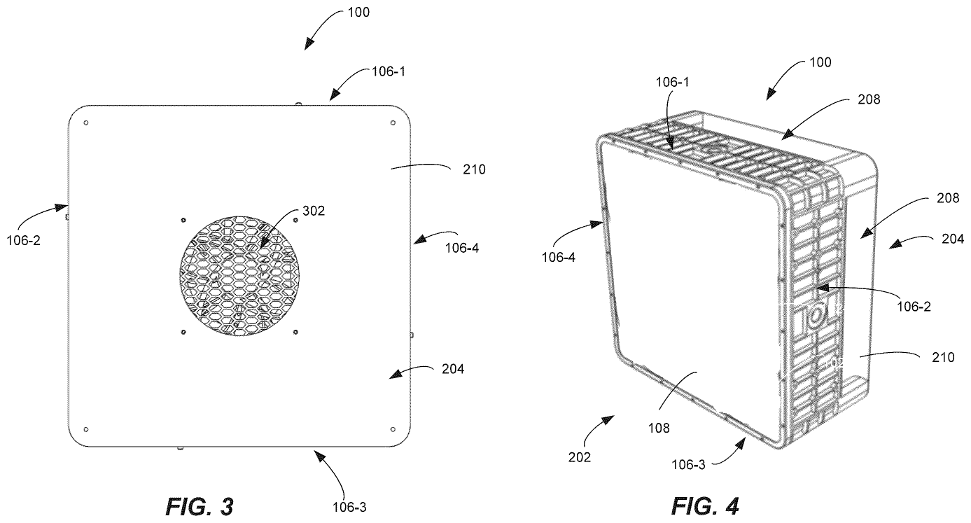

FIG. 3 depicts a rear view of LED assembly 100 of FIG. 1 in an exemplary embodiment. In FIG. 3, rear portion 204 of LED assembly 100 depicts a fan 302 of LED assembly 100, which is controlled by controller 110. Fan 302 includes a plurality of fan blades that draw air into LED assembly 100 at rear portion 204 and expel the air utilizing vents 208 (see FIG. 2). Vents 208 extend along sides 106-1, 106-2, 106-3, 106-4 of LED assembly 100 such that when LED assemblies 100 are assembled into an array to form a LED panel, vents 208 of different LED assemblies 100 interlock with each other to provide an air path through the LED panel to the sides of the LED panel. Controller 110 may modify the operation of fan 302 in order to vary the airflow through LED assembly 100 and/or a LED panel generated by LED assemblies 100 in order to provide cooling to the LED panel.

In this embodiment, LED assembly 100 includes a rear panel 210, which extends across rear portion 204 of LED assembly 100 between sides 106-1, 106-2, 106-3, 106-4 of LED assembly 100.

FIG. 4 depicts an isometric front view of LED assembly 100 of FIG. 1 in an exemplary embodiment. In FIG. 4, the orientation of vents 208 with respect to rear portion 204 and rear panel 210 of LED assembly 100 is more clearly visible. Although vents 208 in this embodiment are depicted as having a particular size and shape, vents 208 may have other sizes and shapes in other embodiments.

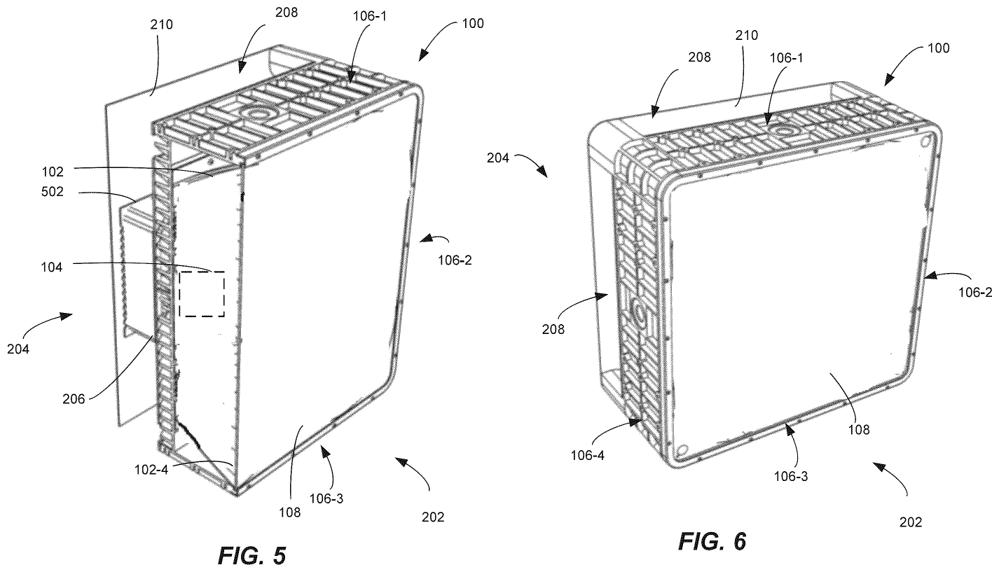

FIG. 5 depicts an isometric front view of the LED assembly 100 of FIG. 1 along cut lines A-A in an exemplary embodiment. In FIG. 5, the orientation of rear panel 210, shroud 206, reflector 102 LEDs 104, and diffuser panel 108 is more clearly visible. FIG. 5 illustrates that rear panel 210 includes an opening 502 that circumscribes shroud 206 and provides a path for airflow into LED assembly 100 through shroud 206.

FIG. 6 depicts an isometric front view of the LED assembly 100 of FIG. 1 with diffuser panel 108 in an exemplary embodiment. In FIG. 6, Reflector 102 and their corresponding LEDs 104 are hidden behind diffuser panel 108.

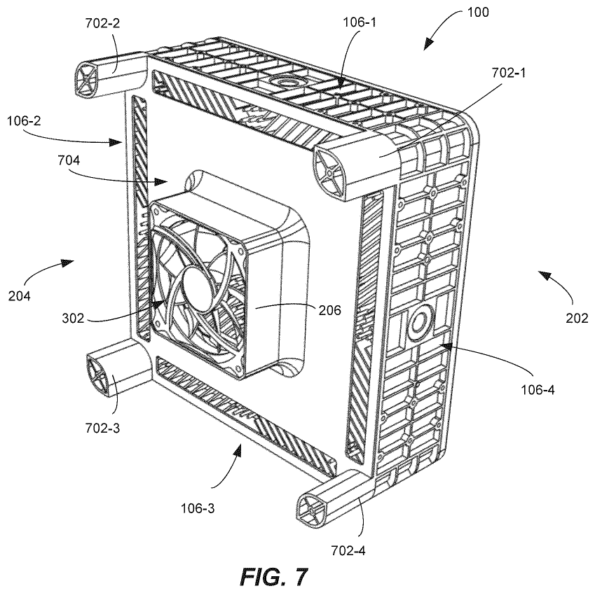

FIG. 7 depicts an isometric rear view of the LED assembly 100 of FIG. 1 with rear panel 210 removed in an exemplary embodiment. With rear panel 210 of LED assembly 100 removed, standoffs 702-1, 702-2, 702-3, 702-4 of LED assembly 100 are more clearly visible. Standoffs 702-1, 702-2, 702-3, 702-4 extend away from a rear surface 704 of LED assembly 100 at rear portion 204. Standoffs 702-1, 702-2, 702-3, 702-4 may be used to secure rear panel 210 to LED assembly 100. Standoffs 702-1, 702-2, 702-3, 702-4 are located at the corners of LED assembly 100 where sides 106-1, 106-2, 106-3, 106-4 intersect each other. FIG. 7 also illustrates that shroud 206, which surrounds fan 302, also extends away from rear surface 704 of LED assembly 100.

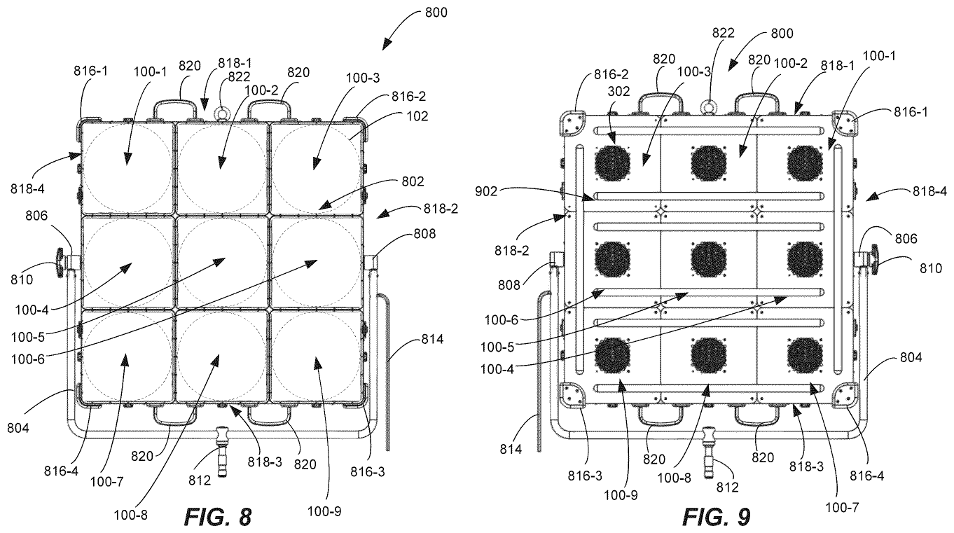

FIG. 8 depicts a front view of a LED panel 800 that utilizes an array of LED assemblies 100 of FIG. 1 in an exemplary embodiment. In this embodiment, LED panel 800 includes nine LED assemblies 100 interlocked together, shown as LED assemblies 100-1, 100-2, 100-3, 100-4, 100-5, 100-6, 100-7, 100-8, 100-9. Although LED panel 800 is depicted as including nine LED assemblies 100 in this embodiment, LED panel 800 may include more or fewer LED assemblies 100 in other embodiments. In this embodiment, FIG. 8 depicts a front portion 802 of LED panel 800, which is a surface that includes reflector 102 of LED assemblies 100. In this embodiment, LED panel 800 includes a light stand 804 that supports LED panel 800, and attachment points 806, 808 for light stand 804 where light stand 804 attaches to LED panel 800. Light stand 804 in this embodiment includes a tension device 810 that secures LED panel 800 in different orientations with respect to light stand 804. Tension device 810 may provide a variable friction lock between light stand 804 and LED panel 800, such that LED panel 800 may be rotated with respect to attachment points 806, 808 and held in place after rotation by tension device 810.

In this embodiment, light stand 804 includes a base portion 812 which may be inserted into a pole, a base, or another external assembly that secures light stand 804 in place with respect to another surface, such as the ground. FIG. 8 further illustrates that a cable 814 extends from light stand 804 in this embodiment. Cable 814 may be used to carry electrical signals for controllers 110 of LED panel 800 (not shown), such as communication signals, power and ground signals, etc., from a remote device to controllers 110 of LED panel 800 (see e.g., FIG. 1). LED panel 800 in this embodiment includes bumpers 816-1, 816-2, 816-3, 816-4 at the corners of LED panel 800, where sides 818-1, 818-2, 818-3, 818-4 of LED panel 800 intersect each other. Bumpers 816-1, 816-2, 816-3, 816-4 may be used to protect LED panel 800 from damage. In particular, FIG. 8 illustrates four bumpers 816-1, 816-2, 816-3, 816-4 for LED panel 800, but LED panel 800 may have a different number of bumpers 816-1, 816-2, 816-3, 816-4 depending on the shape of LED panel 800. Bumper 816-1 is located at the intersection of sides 818-1, 818-4, bumper 816-2 is located at the intersection of sides 818-1, 818-2, bumper 816-3 is located at the intersection of sides 818-2, 818-3, and bumper 816-4 is located at the intersection of sides 818-3, 818-4. In this embodiment, LED panel 800 includes handles 820, which may be used to re-orient LED panel 800 with respect to light stand 804. In this embodiment, LED panel 800 further includes a ring attachment point 822, which may be used to secure LED panel 800 or suspend LED panel 800.

FIG. 9 depicts a rear view of LED panel 800 of FIG. 8 in an exemplary embodiment. In particular, FIG. 9 depicts a rear portion 902 of LED panel 800, where fans 302 of LED assemblies 100-1 through 100-9 are visible. Controllers 110 operate fans 302 draw air into LED panel 800, and the air is ejected from sides 818-1, 818-2, 818-3, 818-4 of LED panel 800 from vents 208 of LED assemblies 100-1, 100-2, 100-3, 100-4, 100-6, 100-7, 100-8, 100-9.

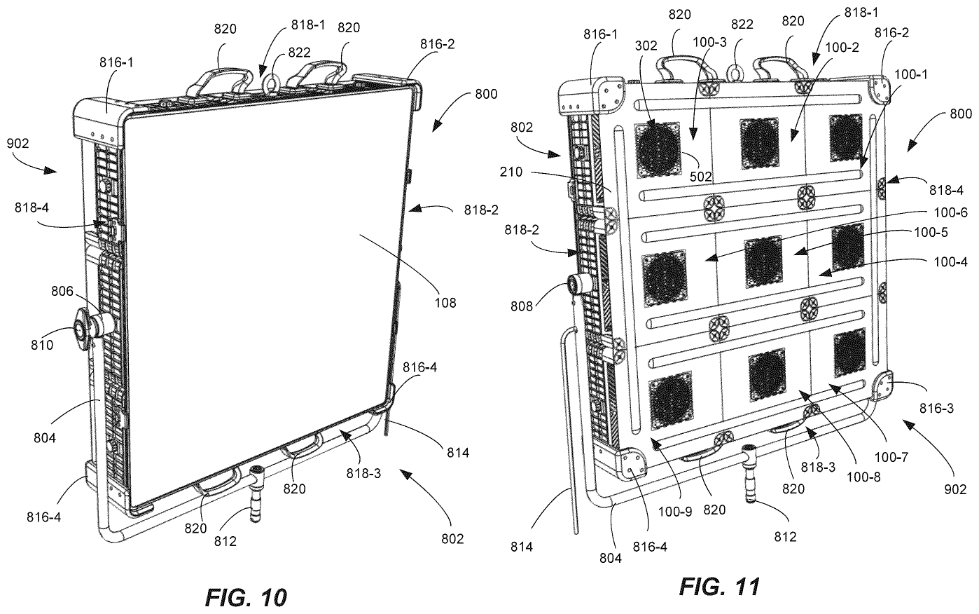

FIG. 10 depicts an isometric front view of the LED panel 800 of FIG. 8 in an exemplary embodiment. In FIG. 10, diffuser panel 108 of LED assemblies 100 obscures both reflector 102 and its corresponding LEDs 104.

FIG. 11 depicts an isometric rear view of the LED panel 800 of FIG. 8 in an exemplary embodiment. In FIG. 11, rear panel 210 and the opening 502 around shroud and fan 302 is more clearly visible. During operation of LED panel 800, controllers 110 operate fans 302 in order to draw air into LED assemblies 100-1, 100-2, 100-3, 100-4, 100-5, 100-6, 100-7, 100-8, 100-9, which cools their respective components. The air is expelled from LED panel 800 at sides 818-1, 818-2, 818-3, 818-4 of LED panel 800.

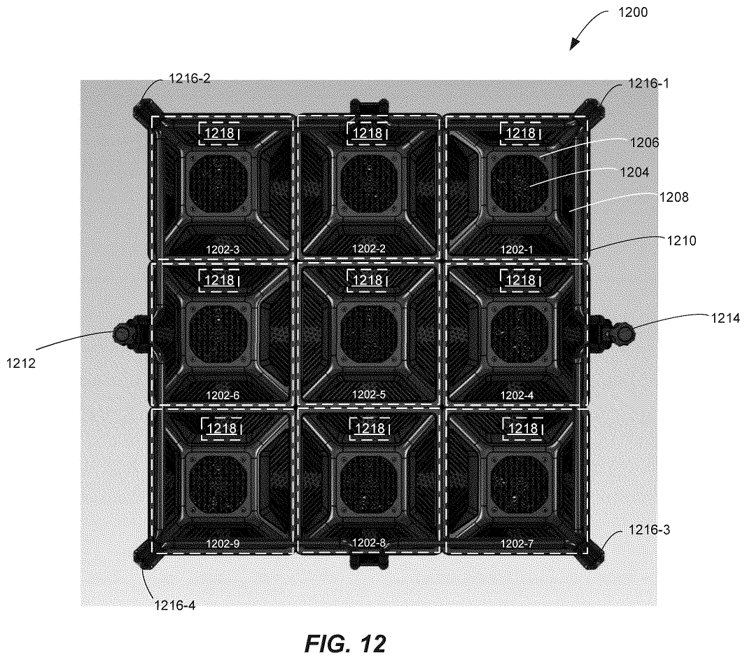

FIG. 12 depicts a rear view of another LED panel 1200 that includes an array of LED assemblies 1202-1, 1202-2, 1202-3, 1202-4, 1202-5, 1202-6, 1202-7, 1202-8, 1202-9 (referred to collectively as LED assemblies 1202) in an exemplary embodiment. LED assemblies 1202 may be similar to LED assemblies 100 described previously. In this embodiment, LED assemblies 1202 each include a fan 1204, a shroud 1206, vents 1208, and a controller 1218 that operate similar to fan 302, shroud 206, vents 208, and controller 110 respectively, previously described for LED assembly 100 (see FIG. 1). LED assemblies 1202 may include wireless or wired interfaces that allow controllers 1218 of LED assemblies 1202 to communicate with each other and with external devices, similar to that previously described with respect to LED assembly 100.

In this embodiment, LED panel 1200 includes nine LED assemblies 1202 interlocked together, shown as LED assemblies 1202-1, 1202-2, 1202-3, 1202-4, 1202-5, 1202-6, 1202-7, 1202-8, 1202-9. Although LED panel 1200 is depicted with nine LED assemblies 1202, LED panel 1200 may include more or fewer LED assemblies 1202 in other embodiments.

In this embodiment, LED panel 1200 includes a support frame 1210, which supports the array of LED assemblies 1202. Support frame 1210 includes pivot interlocks 1212, 1214, which allow LED panel 1200 to rotate with respect to a light stand (not shown) and locked into place after rotation. Support frame 1210 includes four bumpers 1216-1, 1216-2, 1216-3, 1216-4, which protect LED panel 1200 from damage. Bumpers 1216-1, 1216-2, 1216-3, 1216-4 may operate similar to bumpers 816-1, 816-2, 816-3, 816-4 previously described with respect to LED panel 800.

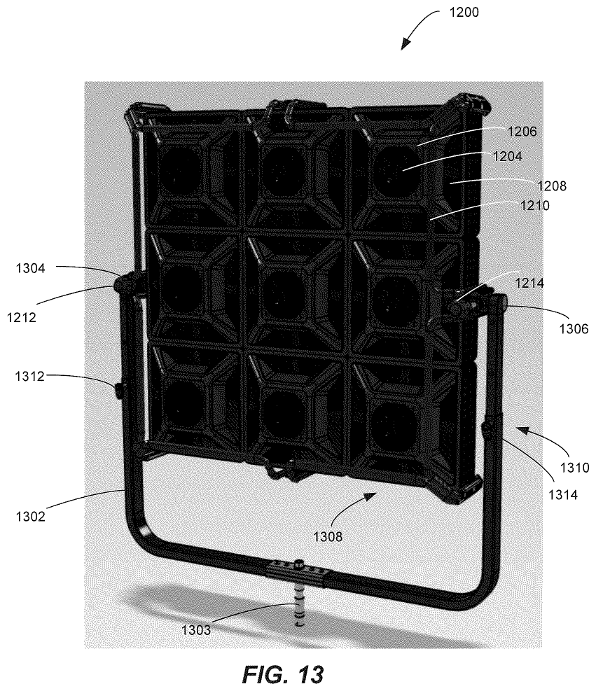

FIG. 13 depicts an isometric rear view of LED panel 1200 of FIG. 12 in an exemplary embodiment. In this embodiment, a light stand 1302 includes a base portion 1303, similar to base portion 812 previously described for light stand 804 (see FIG. 8). Light stand 1302 in this embodiment attaches to support frame 1210 via attachment points 1304, 1306, with pivot interlocks 1212, 1214 at a rear portion 1308 of LED panel 1200 and reflectors of LED assemblies 1202 (not shown) disposed at a front portion 1310 of LED panel 1200. In this embodiment light stand 1302 includes locking members 1312, 1314, which allow a distance between base portion 1303 and LED panel 1200 to be adjusted via a telescoping function of light stand 1302 (e.g., light stand 1302 includes separate tube portions which slide within each other).

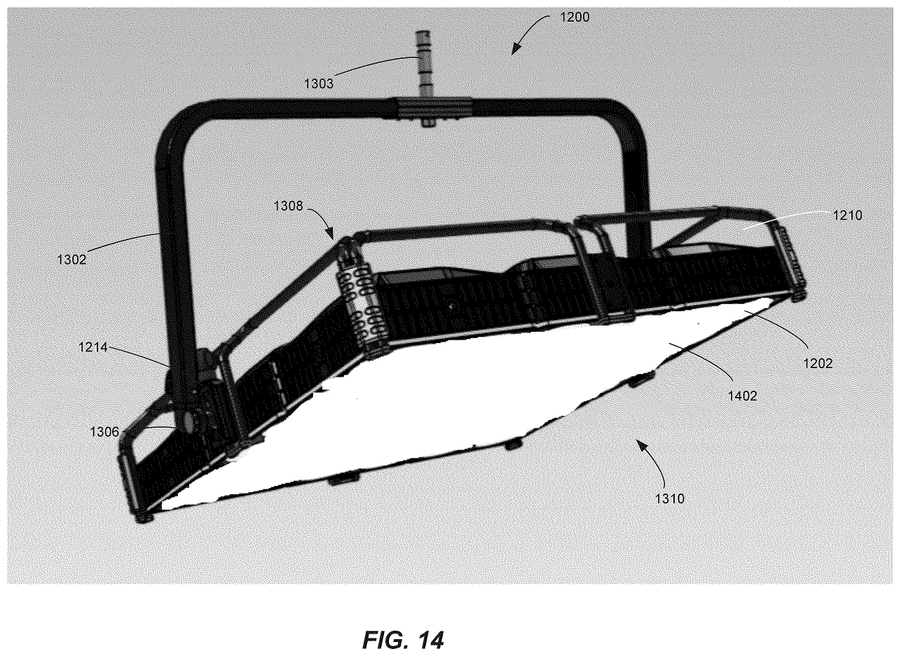

FIG. 14 depicts an isometric front view of LED panel 1200 of FIG. 12 in an exemplary embodiment. In FIG. 14, reflectors of LED assemblies 1202 are hidden behind a diffuser 1402. Each of LED assemblies 1202 include one reflector, similar to LED assembly 100. However, similar to LED assembly 100, LED assemblies 1202 may include more or fewer reflectors in other embodiments.

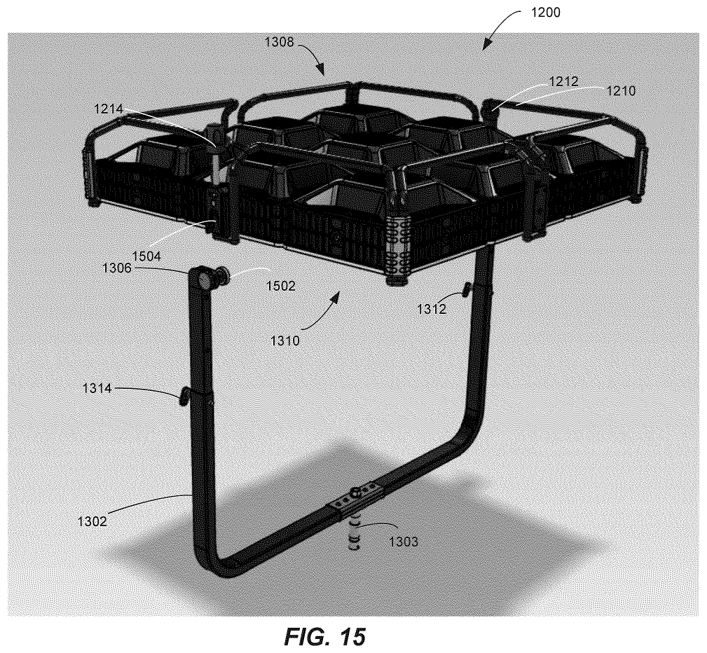

FIG. 15 depicts an isometric side view of LED panel 1200 of FIG. 12 in an exemplary embodiment. FIG. 15 illustrates how light stand 1302 is attached to support frame 1210. In this embodiment, a coupling member 1502 associated with attachment point 1306 is inserted into a channel 1504 of support frame 1210, which locks light stand 1302 to support frame 1210.

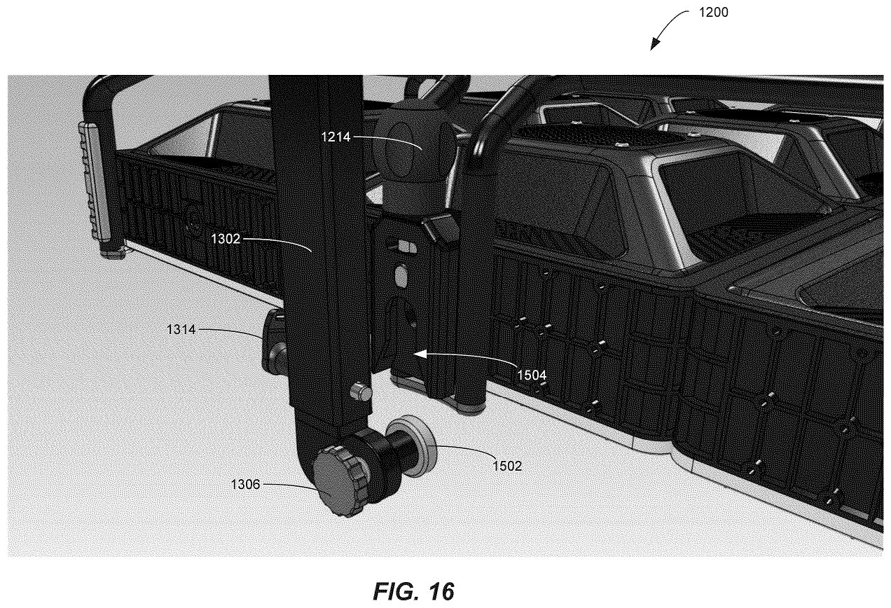

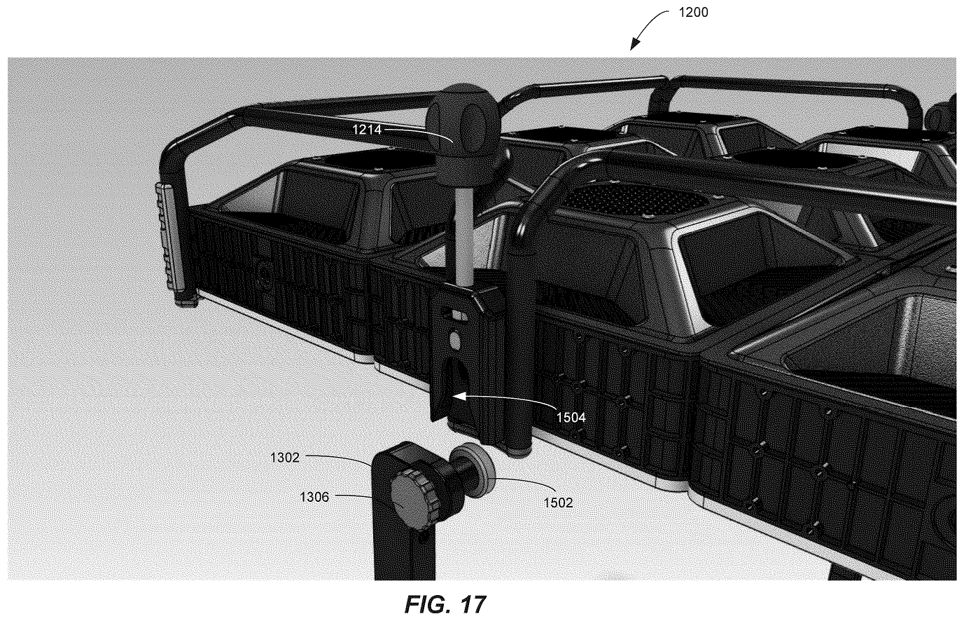

FIGS. 16 and 17 depict additional isometric side views of LED panel 1200 of FIG. 12 in exemplary embodiments. Once coupling member 1502 is inserted into channel 1504, pivot interlock 1214 may be raised or lowered in order to enable LED panel 1200 to rotate with respect to light stand 1302. For example, pivot interlock 1214 is raised (see FIG. 17) to allow LED panel 1200 to rotate with respect to light stand 1302, and pivot interlock is lowered (see FIG. 16) to prevent LED panel 1200 from rotating with respect to light stand 1302.

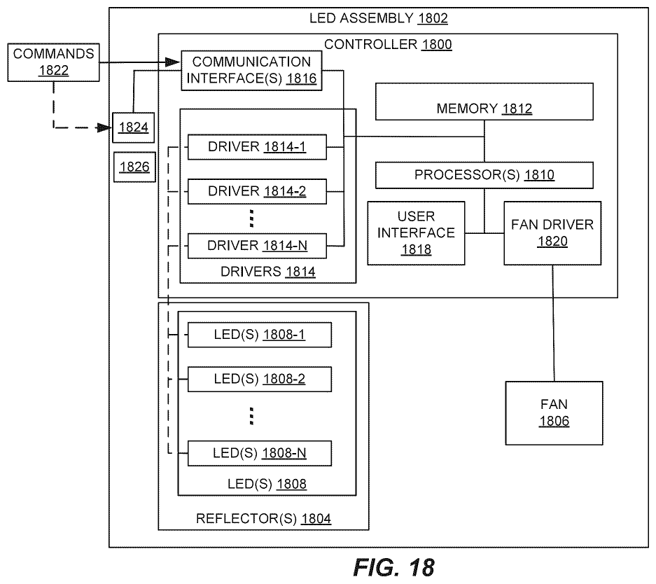

FIG. 18 depicts a block diagram of a controller 1800 for a LED assembly 1802 in an exemplary embodiment. Controller 1800 may be similar to controllers 110, 1218 previously described. Controller 1800 comprises any component, system, or device that performs the functionality described herein for controller 1800. Controller 1800 will be described with respect to various discrete elements, which perform functions. These elements may be combined in different embodiments, segmented into different discrete elements in other embodiments, or removed in some embodiments.

In this embodiment, LED assembly 1802 includes controller 1800, one or more reflectors 1804, and a fan 1806. Reflectors 1804 surround a plurality of LEDs 1808, depicted as LEDs 1808-1, 1808-2, 1808-N, where N is an arbitrary number of LEDs greater than two. Reflectors 1804, LEDs 1808, and fan 1806 may operate similarity to reflector 102 of LED assembly 100, LEDs 104 of LED assembly 100, and fans 302, 1204 of LED assemblies 100, 1202, respectively.

In this embodiment, controller 1800 includes at least one processor 1810 communicatively coupled with at least one memory 1812. In some embodiments, processor 1810 executes programmed instructions (e.g., which may be stored at memory 1812) in order to perform the functionality described herein for controller 1800. In other embodiments, processor 1810 and/or memory 1812 comprises logic that implements the functionality described herein for controller 1800.

In this embodiment, controller 1800 further includes drivers 1814. Drivers 1814 are configured to modify the operation of LEDs 1808. In particular, three drivers 1814-1, 1814-2, 1814-N are illustrated in FIG. 18, with N being an arbitrary number of drivers greater than two, each of which is configured to modify the operation of corresponding LEDs 1808-1, 1808-2, 1808-N. However, in other embodiments, controller 1800 includes a different number of drivers 1814-1, 1814-2, 1814-N and their corresponding LEDs 1808-1, 1808-2, 1808-N.

In this embodiment, controller 1800 further includes one or more communication interfaces 1816, a user interface 1818, and a fan driver 1820 Communication interfaces 1816 may include wired interfaces and/or wireless interfaces. One example of a wired interface is a digital multiplex (DMX) interface. Examples of wireless interfaces include Wi-Fi interfaces, Bluetooth interfaces, cellular network interfaces, and near field communication (NFC) interfaces. Communication interfaces 1816 are configured to receive commands 1822 from an external system for controlling the operation of LED assembly 1802 utilizing controller 1800. For example, an application executing on a user's smartphone may generate commands 1822, which are processed by controller 1800 (e.g., via processor 1810) to control the operation of LED assembly 1802 (e.g., modify the optical output of LEDs 1808, vary the speed of fan 1806, etc.). Processor 1810 may also receive information from a user via user interface 1818 to control the operation of LED assembly 1802.

User interface 1818 may include display screens and buttons, which allow the user to control the operation of controller 1800. For example, a user may utilize user interface 1818 to command controller 1800 to modify the operation of LED assembly 1802, and/or other LED assemblies 1802 when LED assembly 1802 is arranged in an array to form a LED panel. In some embodiment, user interface 1818 provides commands 1822 to processor 1810 via user interaction with user interface 1818. In other embodiments, processor 1810 generates commands 1822 based on a user interaction with user interface 1818.

Fan driver 1820 is controlled by processor 1810 to modify the operation (e.g., speed) of fan 1806. Fan driver 1820 may generate variable voltages and/or currents, and or pulse widths of voltages and/or currents in order to vary the speed of fan 1806.

In this embodiment, drivers 1814 are used to operate LEDs 1808 of LED assembly 1802 under direction of processor 1810. For instance, drivers 1814 may comprise multi-channel LED drivers, with each of drivers 1814-1, 1814-2, 1814-N controlling a different color of LEDs 1808. Thus, processor 1810, using drivers 1814, is configured in some embodiments to operate each color of LEDs 1808 individually. For example, processor 1810 may control each color of LEDs 1808 and individually or collectively, adjust a brightness, a hue, an irradiance pattern, and a saturation of LEDs 1808 as desired.

Similarly to fans 302, 1204 of LED assemblies 100, 1202, respectively, processor 1810 may utilize fan driver 1820 to operate fan 1806 and provide cooling to LED assembly 1802, including providing cooling to LEDs 1808 and controller 1800.

In some embodiments, LED assembly 1802 includes a plurality of electrical connections 1824, 1826 at one or more sides of LED assembly 1802. In this embodiment, electrical connection 1824 provides wired communications between different controllers 1800 of LED assembly 1802 when LED assembly 1802 is arranged in a LED panel. For example, processor 1810 may direct the operation of other processors 1810 of a different LED assembly 1802 when LED assembly 1802 is arranged in a LED panel.

Electrical connection 1826 provides electrical power between different controllers 1800 of LED assembly 1802 when LED assembly 1802 is arranged in a LED panel.

In some embodiments, commands 1822 are received by processor 1810 via communication interfaces 1816 and/or electrical connection 1824 from other controllers 1800 when LED assembly 1802 is arranged in an array of LED assemblies to form LED panel. In some embodiments, commands 1822 comprise DMX commands. In other emblements, processor 1810 forwards commands 1822 received or generated by processor 1810 (e.g., via communication interfaces 1816, and/or electrical connection, 1824, and/or user interface 1818) to other processors 1810 when LED assembly 1802 is arranged in a LED panel. For example, processor 1810 may receive commands 1822 from an external device or another controller 1800 via communication interfaces 1816 and/or electrical connection 1824, and forwards commands 1822 to other controllers 1800 when LED assembly 1802 is arranged in an array of LED assemblies to form LED panel via communication interfaces 1816 and/or electrical connection 1824. In another example, processor 1810 generates commands 1822 based on a user input at user interface 1818, and forwards commands 1822 to other controllers 1800 when LED assembly 1802 is arranged in an array of LED assemblies to form a LED panel via communication interfaces 1816 and/or electrical connection 1824.

An example technical effect of the embodiments described herein includes at least improving lighting in still picture, video, and film production environments utilizing controllers of LED assemblies, which may be organized into an array to form a LED panel.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a controller configured to modify an operation of a light emitting diode (LED) assembly, the controller comprising:
at least one processor;
at least one LED driver configured to electrically coupled to at least one LED of the LED assembly, wherein at least one reflector disposed at a front portion of the LED assembly surrounds the at least one LED; and
a fan driver configured to electrically couple with a fan of the LED assembly, wherein a shroud surrounds the fan and extends from a rear portion of the LED assembly towards the front portion, and wherein at least one vent of the LED assembly is in fluid communication with the shroud,
wherein the at least one processor is configured to receive external commands to:
modify, utilizing the at least one LED driver, an optical output of the at least one LED of the LED assembly based on the external commands; and
modify, utilizing the fan driver, a speed of the fan based on the external commands.

2. The system of claim 1, wherein:
the controller further comprises a wired communication interface configured to provide, via communications received by the wired communication interface, the external commands to the at least one processor, wherein the wired communication interface is configured to electrically couple with electrical connections disposed at one or more sides of the LED assembly.

3. The system of claim 2, wherein the wired communication interface comprises a digital multiplex (DMX) interface, and wherein the external commands comprise DMX commands.

4. The system of claim 2, wherein the LED assembly is organized into an array of LED assemblies to form a LED panel, and wherein:
the at least one processor of one of the LED assemblies is configured to communicate with the at least one processor of another one of the LED assemblies utilizing the wired communication interface.

5. The system of claim 4, wherein:
the at least one processor of the one of the LED assemblies is configured to forward the external commands to the at least one processor of the other one of the LED assemblies utilizing the wired communication interface.

6. The system of claim 4, wherein:
the at least one processor of the one of the LED assemblies is configured to direct operation of the at least one processor of the other one of the LED assemblies based on the external commands utilizing the wired communication interface.

7. The system of claim 1, wherein:
the controller further comprises a wireless communication interface configured to provide, via communications received by the wireless communication interface, the external commands to the at least one processor.

8. The system of claim 7, wherein the wireless communication interface comprises one or more of a Wi-Fi interface, a Bluetooth interface, a cellular network interface, and a near field communication (NFC) interface.

9. The system of claim 7, wherein the LED assembly is organized into an array of LED assemblies to form a LED panel, and wherein:
the at least one processor of one of the LED assemblies is configured to communicate with the at least one processor of another one of the LED assemblies utilizing the wireless communication interface.

10. The system of claim 9, wherein:
the at least one processor of the one of the LED assemblies is configured to forward the external commands to the at least one processor of the other one of the LED assemblies utilizing the wireless communication interface.

11. The system of claim 9, wherein:
the at least one processor of the one of the LED assemblies is configured to direct operation of the at least one processor of the other one of the LED assemblies based on the external commands utilizing the wireless communication interface.

12. The system of claim 1, wherein:
the controller further comprises a user interface configured to provide, via user interaction with the user interface, the external commands to the at least one processor.

13. The system of claim 12, wherein:
the controller further comprises a wired communication interface configured to electrically couple with electrical connections disposed at one or more sides of the LED assembly,
the LED assembly is organized into an array of LED assemblies to form a LED panel, and
the at least one processor of one of the LED assemblies is configured to communicate with the at least one processor of another one of the LED assemblies utilizing the wired communication interface.

14. The system of claim 13, wherein:
the at least one processor of the one of the LED assemblies is configured to forward the external commands to the at least one processor of the other one of the LED assemblies utilizing the wired communication interface.

15. The system of claim 13, wherein:
the at least one processor of the one of the LED assemblies is configured to direct operation of the at least one processor of the other one of the LED assemblies based on the external commands utilizing the wired communication interface.
